(19) United States
(12) Patent Application Publication
(10) Pub. No.: US 2017/0053491 A1
(43) Pub. Date: Feb. 23, 2017

(54) METHOD AND SYSTEM PERMITTING FUNDS TRANSFERS AND WAGERS ON MULTIPLE GAMES

(71) Applicants: Milo Borissov, Dubai Sports City (AE); Rossi McKee, Indianapolis, IN (US)

(72) Inventors: Milo Borissov, Dubai Sports City (AE); Rossi McKee, Indianapolis, IN (US)

(21) Appl. No.: 15/238,865

(22) Filed: Aug. 17, 2016

Related U.S. Application Data
(60) Provisional application No. 62/206,468, filed on Aug. 18, 2015.

(51) Int. Cl. G07F 17/32

(52) U.S. Cl. CPC G07F 17/3244; G07F 17/3211; G07F 17/3209; G07F 17/3225; G07F 17/3218

(57) ABSTRACT

A method and system are provided for permitting funds transfers and wagers on multiple games at a single gaming device. The player of a single gaming device can play different games at the same time. The player has a funds balance relative to each game being played and can conveniently transfer funds between those games.

### RELATED APPLICATION DATA

This application claims priority to U.S. Provisional Application Ser. No. 62/206,468, filed Aug. 18, 2015.

### FIELD OF THE INVENTION

The present invention relates to gaming systems which are configured to present wagering games.

### BACKGROUND OF THE INVENTION

In order to keep players interested in their games, gaming machine manufacturers continue to develop new games. These new games may be offered by new stand-alone gaming machines or a single machine might be programmed or configured to present more than one game. A player might utilize a menu to select a particular desired game for play.

Some players like to play more than one game at the same time. In some instances, a player will sit at or next to two stand-alone gaming machines. The player manually plays both gaming machines at the same time in order to increase the excitement of game play. However, this requires that the player awkwardly reach between the two gaming machines and separately fund each gaming machine (such as by providing a value ticket or monetary funds into the machine).

New and exciting methods and machine for offering multiple games for play by a player are desired.

### SUMMARY OF THE INVENTION

Embodiments of the invention comprise a methods and systems for permitting funds transfers and wagers on multiple games presented via a single gaming device.

In accordance with one embodiment of a method of the invention, at least one menu of games is presented to a player of a gaming device. The player selects one game from the at least one game menu to comprise a primary game. The player selects one or more additional games from the at least one game menu to comprise a secondary game.

The player provides funds to the gaming device for placing wagers. The funds may be provided by currency, coin, credit or debit card, account transfer, ticket or the like. The funds are credited to a primary game credit balance associated with the primary game.

Importantly, the player can move or transfer funds from the primary game to one or more of the secondary games. The player may provide input regarding a number of credits to transfer from the primary game to a secondary game. That number of credits is transferred to a secondary game credit balance (and deducted from the primary game credit balance).

Winnings or awards for secondary game wins may be credited to the secondary game credit balance. The player may elect to transfer those credits (or any other credits comprising the secondary game credit balance) to the primary game credit balance.

The invention permits a player to fund wagers on two or more games starting from a single credit balance.

The principles of the invention may be implemented at a traditional casino-style gaming machine, a video lottery or server-based gaming terminal or a game presentation device such as a PDA or computer. The invention may be applied to fund wagers on games generated and presented directly at the gaming device, at a server, or even at another device such as a gaming table, or combinations thereof.

In a preferred embodiment, a player of a single gaming machine can play different games at the same time. The player has a funds balance relative to each game being played and can conveniently transfer funds between those games.

Further objects, features, and advantages of the present invention over the prior art will become apparent from the detailed description of the drawings which follows, when considered with the attached figures.

### DESCRIPTION OF THE DRAWINGS

FIG. 1 schematically illustrates a system in accordance with the present invention.

FIG. 2 illustrates an embodiment of a gaming machine of the system illustrated in FIG. 1.

FIGS. 3A-3D illustrate an example implementation of the present invention.

### DETAILED DESCRIPTION OF THE INVENTION

In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

Embodiments of the invention comprise a method and system for permitting funds transfers and wagers on multiple games. In a preferred embodiment, a player of a single gaming device can play different games at the same time. The player has a funds balance relative to each game being played and can conveniently transfer funds between those games.

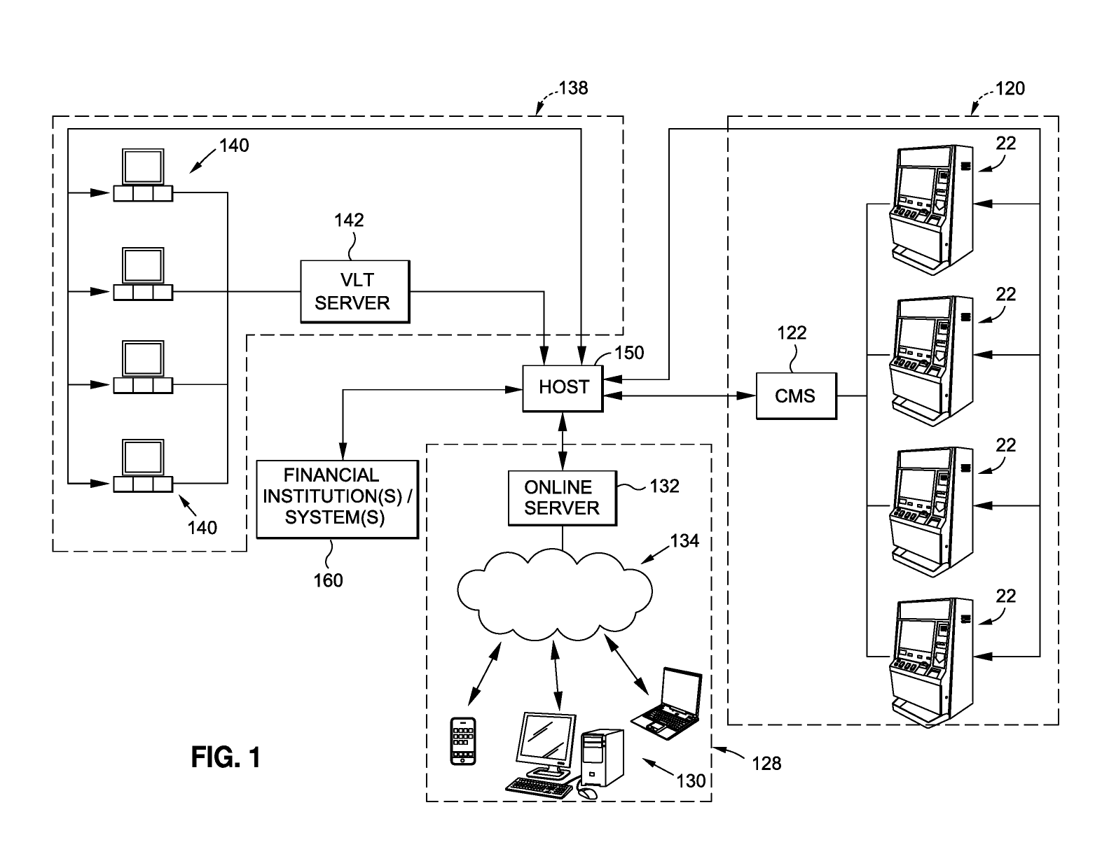

FIG. 1 schematically illustrates features of one embodiment of a gaming system 100 in accordance with the invention. The gaming system 100 may include one or more traditional casino gaming systems 120. In those gaming systems 120, one or more gaming devices may be associated with a gaming or casino management system (“CMS”). Such a system may include at least one host or casino management server 122. The casino management host 122 may comprise one or more computing devices, such as servers, which are in communication with the gaming devices.

The gaming devices may comprise gaming machines 22, mobile gaming devices such as hand-held or tablet devices, or other devices such as automated or semi-automated gaming tables and the like, as are well known.

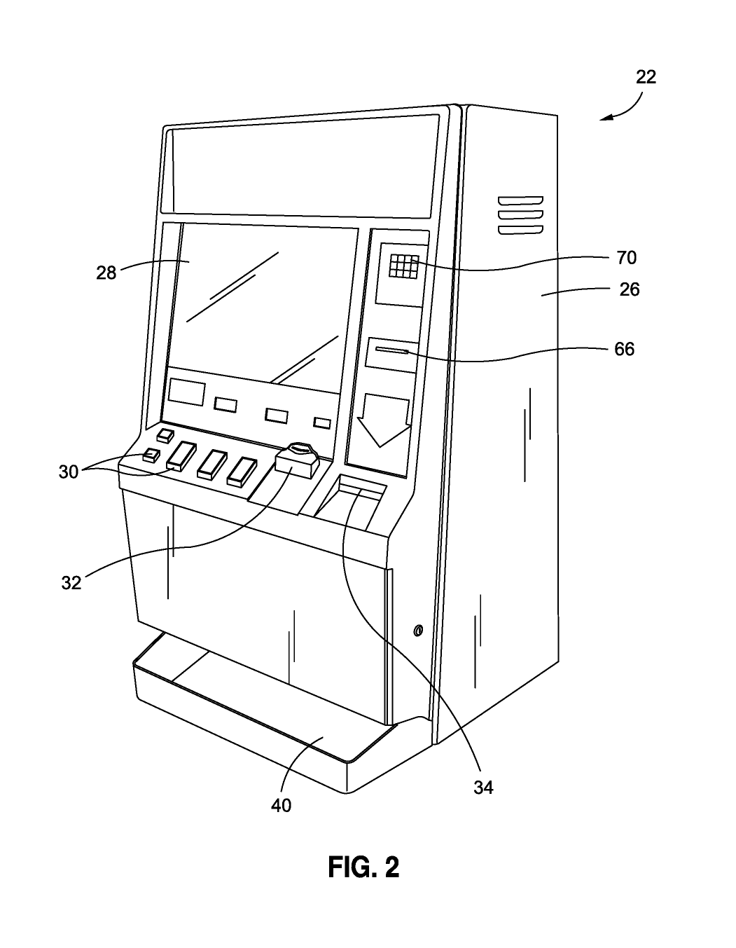

One example of a gaming machine 22 of a casino gaming system 120 is illustrated in FIG. 2. As illustrated, the gaming machine 22 generally comprises a housing or cabinet 26 for supporting and/or enclosing various components required for operation of the gaming machine. In the embodiment illustrated, the housing 26 includes a door located at a front thereof, the door capable of being moved between an open position which allows access to the interior, and a closed position in which access to the interior is generally prevented. The configuration of the gaming machine 22 may vary. In the embodiment illustrated, the gaming machine 22 has an “upright” configuration. However, the gaming machine 22 could have other configurations, shapes or dimensions (such as being of a “slant”-type, “bar-top” or other configuration as is well known to those of skill in the art).

The gaming machine 22 preferably includes at least one display device 28 configured to display game information. The display device 28 may comprise an electronic video display such as a cathode ray tube (CRT), high resolution flat panel liquid crystal display (LCD), projection LCD, plasma display, field emission display, digital micro-mirror display (DMD), digital light processing display (DLP), LCD touchscreen, a light emitting display (LED) or other suitable displays now known or later developed, in a variety of resolutions, sizes and formats (e.g. 4:3, widescreen or the like). The display 28 may be capable of projecting or displaying a wide variety of information, including images, symbols and other indicia or information associated with game play, game promotion or other events. The gaming machine 22 might include more than one display device 28, such as two or more displays 28 which are associated with the housing 26. The gaming machine 22 might also include a top box or other portion. Such a top box might include one or more display devices 28, such as in addition to one or more main displays which are associated with the housing 26. Also, the gaming machine 22 might include side displays (such as mounted to the exterior of the housing 26) and might include multiple displays of differing sizes.

As described in more detail below, the gaming machine 22 is preferably configured to present one or more games upon a player making a monetary payment or wager. In this regard, as described in more detail below, the gaming machine 22 includes means for accepting monetary value.

In one embodiment, as detailed above, certain game outcomes may be designated as winning outcomes. Prizes or awards may be provided for winning outcomes, such as monetary payments (or representations thereof, such as prize of credits), or promotional awards as detailed herein. As detailed below, the gaming machine 22 includes means for returning unused monetary funds and/or dispensing winnings to a player.

The gaming machine 22 preferably includes one or more player input devices 30 (such as input buttons, plunger mechanisms, a touch-screen display, joystick, touch-pad or the like). These one or more devices 30 may be utilized by the player to facilitate game play, such as by providing input or instruction to the gaming machine 22. For example, such input devices 30 may be utilized by a player to place a wager, cause the gaming machine 22 to initiate a game, to indicate cards to be held or discarded, to “cash out” of the gaming machine, or to provide various other inputs.

In one preferred embodiment, the gaming machine 22 includes at least one microprocessor or controller for controlling the gaming machine, including receiving player input and sending output signals for controlling the various components or peripheral devices of the machine 22 (such as generating game information for display by the display 28). The controller may be arranged to receive information regarding funds provided by a player to the gaming machine, receive input such as a purchase/bet signal when a purchase/bet button is depressed, and receive other inputs from a player. The controller may be arranged to generate information regarding a game, such as generating game information for display by the at least one display 28, for determining winning or losing game outcomes and for displaying information regarding awards for winning game outcomes, among other things.

The controller may be configured to execute machine readable code or “software” or otherwise process information, such as obtained from a remote server. Software or other instructions may be stored at a memory or data storage device, e.g. in a fixed or non-transitory configuration. The memory may also store other information, such as pay table information. The gaming machine 22 may also include one or more random number generators for generating random numbers, such as for use in selecting slot symbols, cards or other game symbols (depending upon the game being presented) and for presenting the game in a random fashion (e.g. whereby the game is presented in a manner in which the player cannot control the outcome) or pseudo-random fashion (e.g. such as where the game includes a skill component which can affect the outcome of the game).

Preferably, the controller is configured to execute machine readable code or instructions which are configured to implement the game. In this regard, the gaming machine is specially configured to present the game of the invention via specific software and/or hardware which causes the gaming machine to operate uniquely. For example, the controller of the gaming machine 22 may be configured to detect a wager, such as a signal from a player's depressing of the “bet one” button. Upon such an event and/or the player otherwise signaling the gaming machine to present the game, the controller may be configured to cause the at least one display 28 to display unique information, such as a unique graphical interface or unique game display, including game symbols or other game information. The controller may accept input from a player of game inputs, such as a request to spin reels or the like, via the one or more player input devices of the gaming machine 22. It will be appreciated that the machine readable code may be configured in various manners, such as by having various “modules” of software which are designed to implement specific features of the game play or game presentation.

The gaming machine 22 may be configured to generate and present games in a stand-alone manner or it may be in communication with one or more external devices at one or more times. For example, the gaming machine 22 may be configured as a server based device and obtain game code or game outcome information from a remote game server (in which event the gaming machine controller may receive game information from the server, such as game outcome information, and use that server-generated information to present the game at the gaming machine).

As indicated, the gaming machine 22 is configured to present one or more wagering games. The gaming machines 22 is preferably configured to accept value, such as in the form of coins, tokens, paper currency or other elements or devices representing value such as monetary funds. Thus, as indicated above, the gaming machine 22 preferably includes a mechanism or means for accepting monetary value. For example, as illustrated in FIG. 1, the gaming machine 22 might include a coin acceptor 32 for accepting coins. Of course, associated coin reading/verifying devices and coin storage devices may be associated with the gaming machine 22 if it is configured to accept coins. Likewise, the gaming machine 22 might include a media reader 34. Such a reader may be configured to accept and read/verify paper currency and/or other media such as tickets. Of course, in such event the gaming machine 22 may further be configured with one or more paper currency or ticket storage devices, such as cash boxes, and other paper currency or media handling devices (including transport devices).

The gaming machine 22 might also be configured to read FOBs, magnetic stripe cards or other media having data associated therewith and via which value or funds may be associated with the gaming machine 22. The mechanism for accepting monetary value might also comprise hardware and/or software which allows a player to transfer (such as electronically) funds from an account, such as a casino wagering account, or a bank or other financial institution account. Such a mechanism might include a communication interface which permits the gaming machine to communicate with a mobile phone, PDA, tablet or other electronic device of the player (such as via a physical interface or wired or wireless communications, such as to enable the transfer of funds from the player to the gaming machine or system.

When the player associates funds with the gaming machine or an associated system, a credit balance is generated. The credit balance may comprise a plurality of monetary value credits. The player may wager some or all of the associated monetary value, such as by wagering one or more of the credits associated with the credit balance. For example, the player might provide input to a wager button or touch screen interface to wager a certain number of credits (such as “Bet 1 Credit”, “Bet 5 Credits”, “Bet Maximum Credits” or other options). In one embodiment, when the player's wager is received, the player's credit balance is reduced by the number of wagered credits. The player might then provide a separate input to begin the game. In other embodiment, the player might select a “play game” input, such as by pressing a “spin” button, which input is taken to comprise both an instruction to place a wager (such as of a pre-set or pre-selected number of credits) and to start the game. Of course, other configurations may be implemented for accepting monetary value from the player and for allowing the player to place a wager from the associated monetary value.

In one embodiment, the gaming machine 22 is configured to award winnings for one or more winning wagering game outcomes. Such winnings may be represented as credits, points or the like. In one embodiment, the player may “cash out” and thus remove previously associated funds and any awarded winnings or such may otherwise be paid to the player. These winnings may be associated with the player's credit balance, thus increasing the player's credit balance.

In one embodiment, the player may provide an input to the gaming machine 22 to indicate their desire to cash out, such as by selecting a “cash out” button or touch screen feature or providing other input. In response, a monetary value represented by the player's credit balance or the like is preferably paid, transferred or otherwise provided to the player. For example, upon an award or at cash-out, associated funds may be paid to the player by the gaming machine 22 dispensing coins to a coin tray. In another embodiment, funds may be issued by dispensing paper currency. In yet another embodiment, a player may be issued a media, such as a printed ticket, which ticket represents the value which was paid or cashed out of the machine. The aspects of gaming machine “ticketing” systems are well known. One such system is described in U.S. Pat. No. 6,048,269 to Burns, which is incorporated herein in its entirety by reference. In yet another embodiment, the cash-out might result in the dispensing of a card or other media which stores or represents the cashed-out funds, such as by writing funds information to a magnetic stripe of a card which is inserted into a media writer of the gaming machine or dispensed from the machine. In other embodiments, the cash-out mechanism may result in the funds value being transferred to an external device or account, such as a player's casino account (such as associated with a casino server), a remote bank or other financial account, or an electronic device such as a player's phone, PDA or tablet.

The gaming machine 22 may also include a player tracking device, such as a card reader 66 and associated keypad 70. Such player tracking devices are well known and may permit the game operator to track play of players of the gaming machine. The tracked play may be utilized to offer player bonuses or awards.

It will be appreciated that the gaming machine illustrated in FIG. 2 is only exemplary of one embodiment of a gaming machine. For example, it is possible to for the gaming machine to have various other configurations, including different shapes and styles and having different components than as just described. Such gaming machines may be referred to a spinning reel or “slot” machines (such as when configured to include spinning reel type displays or to display spinning reel type video information) or video gaming machines, and may be configured to implement a variety of games now known or later developed, including, but not limited to slot games, poker games, blackjack games, lotteries, bingo games, keno games, roulette games, baccarat games and others.

In a preferred embodiment, as detailed below, the gaming machine 22 is capable of permitting game play of at least two different games at the same time. The games might comprise games which are presented directly via the gaming machine 22 or they could comprise games presented or generated by other devices, such as remote gaming tables or the like.

The gaming system 100 might include one or more online gaming systems 128 and other types of gaming devices. Such systems 128 might be configured to present games via communication links or networks to one or more gaming devices in the form of computing or presentation devices 130, such as a home or office computer or a player's mobile electronic device such as a PDA, phone or the like. In one embodiment, one or more games (preferably wager based games) may be presented at those devices 130 via one or more online game servers 132. For example, a player might log into a game server 132 and the controller thereof might cause game information to be delivered to the player's computing device 130 via a communication link. The communication link might comprise or include the Internet and/or other networks, such as a wired or wireless LAN, or combinations of public and/or private networks including wired and/or wireless links. In such a configuration it will be noted that the term “controller” may comprise more than one device. For example, in a server-based environment, a controller at a server may generate game information and transmit that information to a local controller at a player's computing device. The local controller at the gaming machine or the player's computer or other electronic device may then cause game information to be displayed on one or more associated displays.

As illustrated in FIG. 1, the gaming system 100 may also include gaming devices in the form of one or more video lottery or server-based gaming systems 138. Such a system 138 might include one or more video lottery terminals (“VLTs”) 140 or similar devices, such as server-based casino gaming terminals. These video lottery or server-based casino terminals 140 may be display devices or computing devices which are configured to present one or more games, such as wagering games including video lottery games, or to display the outcomes of such games. Once again, such devices may have wager accepting devices for establishing credit balances for placing wagers and may provide credit cash-out mechanisms similar those described above.

The terminals 140 may be associated with one or more servers 142, such as video lottery or casino game servers. The servers 142 may be connected to the terminals 140 and be configured to enable or track the presentation of video lottery games at the terminals 140.

In accordance with a method and system of the invention, a player can play multiple games, preferably via a single gaming device (such as a single gaming machine 22, VLT 140, or presentation device 130) and can transfer funds between those games.

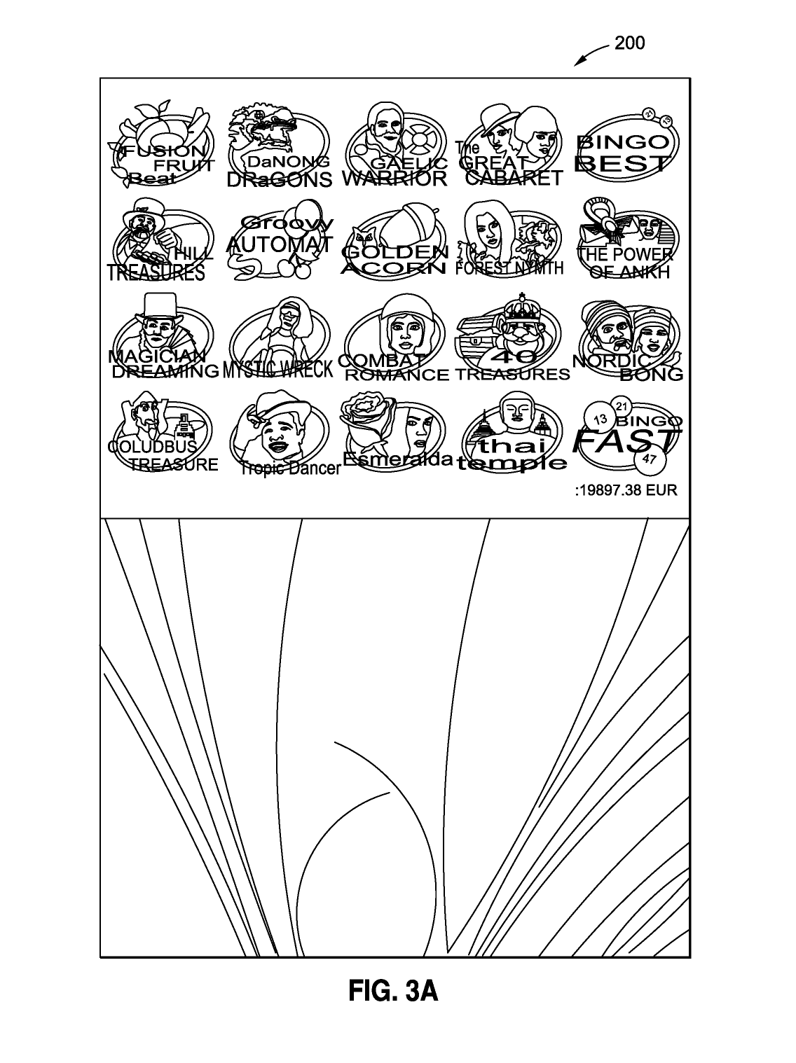

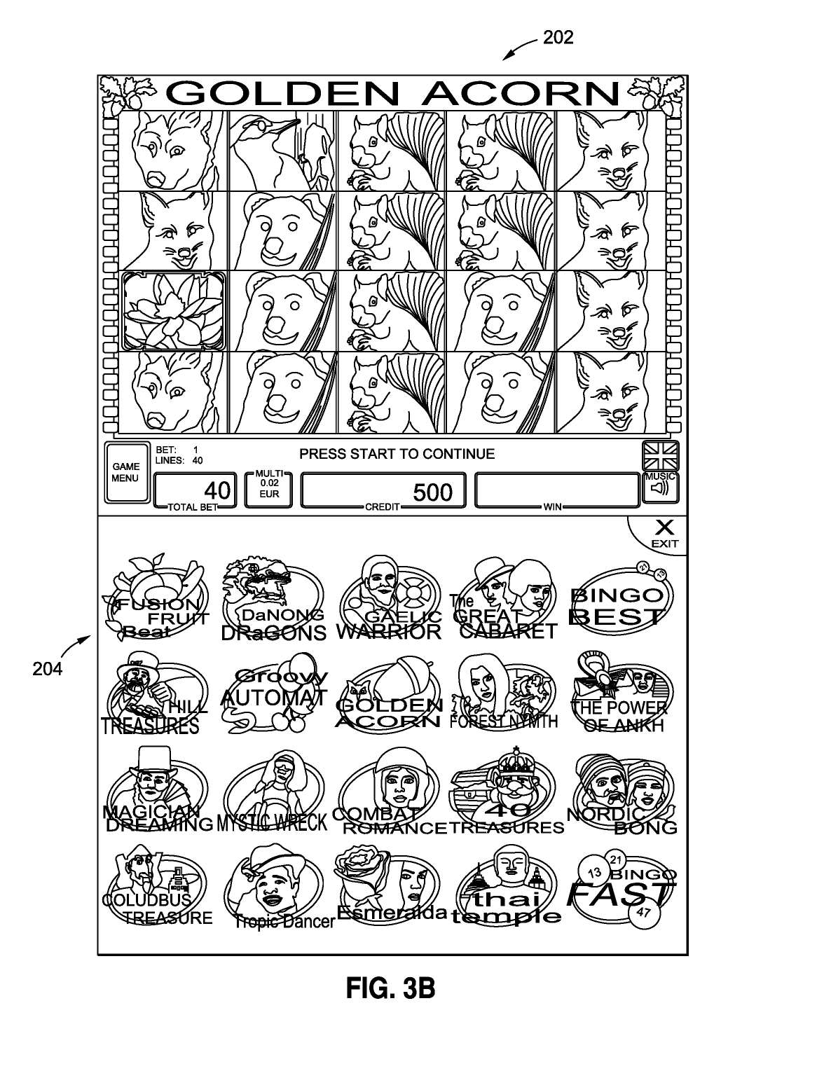

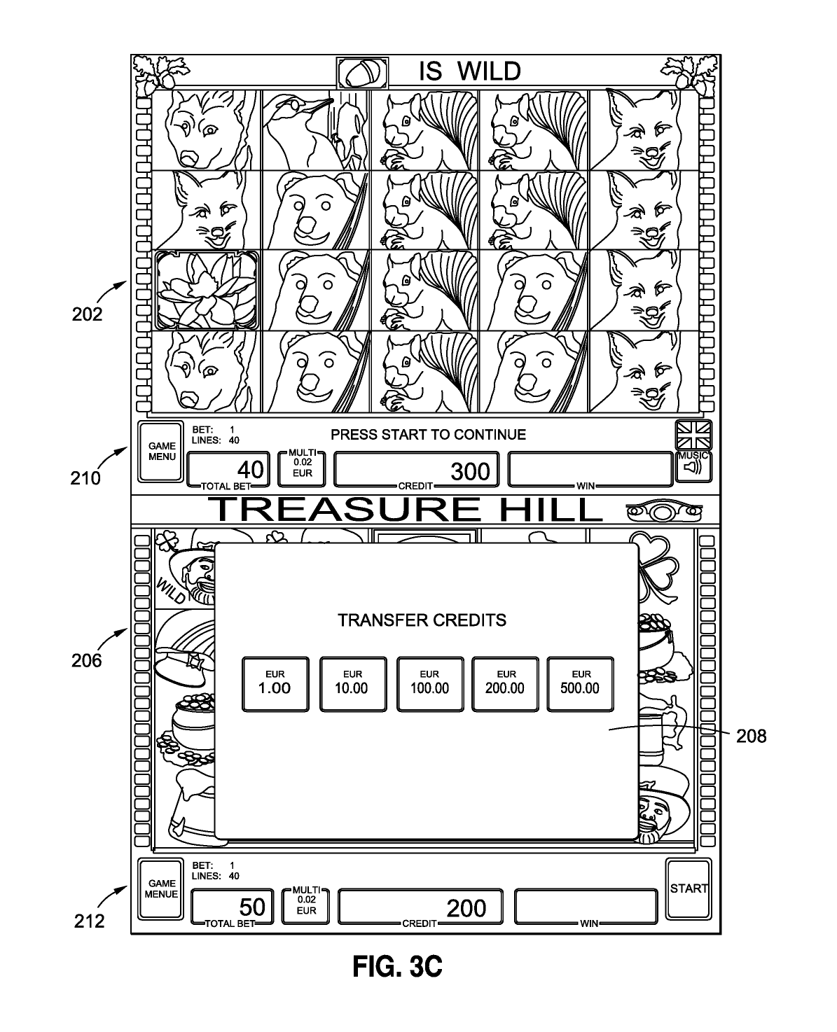

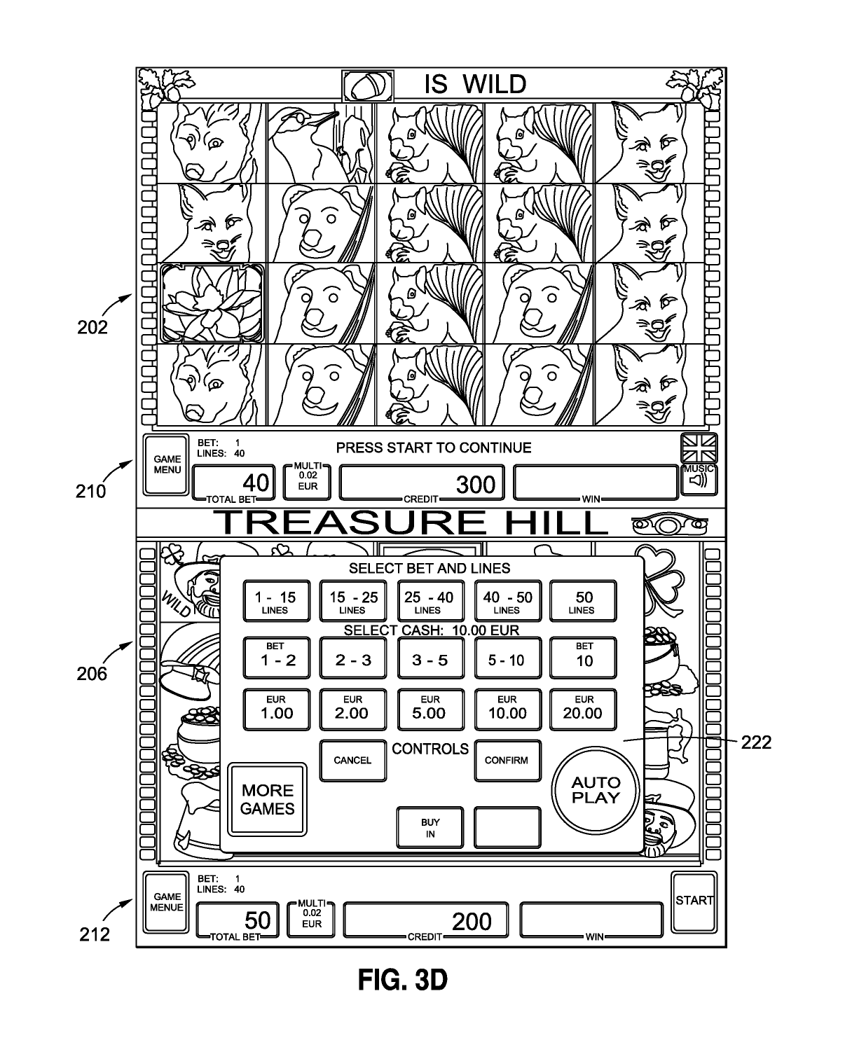

One embodiment of the invention will be described with reference to FIGS. 3A-3D relative to a gaming machine 22 such as that described above (although the invention could similarly be presented at other types of gaming devices). As illustrated in FIG. 3A, a gaming machine 22 may be configured to present one or more menus of games. Of course, the number of game options which are presented to the player may vary, such as based upon the configuration of the gaming machine (such as determined by the manufacturer of the gaming machine or the casino). The particular games which are offered to the player may vary and comprise slot-type games (electronic or physical spinning reel), poker games, blackjack games, bingo games, keno games, roulette games, baccarat games and other games now known or later invented. In one embodiment, the games may be generated at the gaming machine 22, at an associated game server, or even via one or more remote game tables. For example, a player might elect to play a video slot game which is generated at the gaming machine 22 and a remote roulette game which is generated at a remote roulette game table, the results of which are displayed or presented at the gaming machine 22.

FIG. 3A illustrates a configuration in which a video display of the gaming machine 22 displays a menu 200 of video slot games, such as in the form of a graphical user interface from which the player may make selections. A player may select a first game from the menu 200 (such as via touch input or input via other input devices). The first game may be selected as a primary game. As illustrated in FIG. 3B, the player has selected the game “Golden Acorn” for play and primary game information 202 regarding that game is displayed to the player.

As illustrated in FIG. 3B, the gaming machine 22 may also permit the player to select at least one second game. In the embodiment which is illustrated, a menu 204 of games is again displayed to the player. This menu 204 may offer the player the same or different games as the original menu 200. In this embodiment, the primary game information 202 is presented at the top of a graphical interface and the menu of games is presented at a bottom of the graphical interface. However, the information could be displayed in various manners, including by more than one display.

In this example, as illustrated in FIG. 3C, the player has selected a second game “Treasure Hill” and secondary game information 206 regarding that game is presented (such as in place of the second game menu 204). Again, the secondary game information 206 could be displayed in various manners.

In a preferred embodiment of the invention, the multiple player-selected games are presented as wagering games. The player preferably provides monetary or monetary-value funds for funding wagers on the two or more different games. In one embodiment, one of the games is designated as a primary game and other games are designated as secondary games. When the player provides funds to the gaming machine, those funds are initially assigned to the primary game, such as in the form of a number of credits applied to a primary game credit balance. However, the player can transfer or move funds between the primary game and the one or more secondary games. In one embodiment, a player provides monetary or monetary-value funds to the gaming machine 22 and those funds are represented as one or more credits. The funds might also be represented as points or the like.

For example, as illustrated in FIG. 3B, after selecting the primary game the player has provided 500 credits to the gaming machine 22. Those credits might have been provided by input of monies (currency and/or coin) to the gaming machine 22, via a value ticket, credit or debit card, monetary transfer or other mechanism. The funds which are associated with the primary game may be displayed relative to a primary game credit balance via a primary game status bar 210 or by other means. This game status bar 210 may include additional information, such as win information, menu information or selection buttons or the like.

Importantly, the player may transfer some or all of these funds to the secondary game. For example, as illustrated in FIG. 3C, a transfer menu 208 may be provided by which a player may transfer funds from the primary game to the secondary game. The transfer menu 208 might be automatically presented at one or more times, or might be accessed by the player, such as via a game menu button or icon 220.

In this example, the player has elected to transfer 200 credits to the secondary game. In a preferred embodiment, the transferred credits are applied to a secondary game credit balance. The secondary game credit balance may be indicated by a secondary game status bar 212 (which may also provide information regarding and/or other information, such as win information and the like). In this example, once the player has elected to transfer the credits, the number of credits associated with the primary game is reduced (e.g. the primary game credit balance is reduced from 500 to 300) and the number of credits associated with the secondary game is increased (e.g. the secondary game credit balance is increased from 0 to 200).

In one embodiment, the player may elect various play criteria relative to both games. For example, the player might select an “auto play” feature relative to either or both games. The player might also select the number of pay lines to play relative to each game and/or the size of the wager relative to each pay line or the game. Of course, the particular play criteria may depend upon the games which the player has selected. The game play criteria might be selected by the player via at least one game play menu 222. This menu might also be automatically presented (such as when a player selects a primary or secondary game) or from the game menu 220.

As one example, when the games are video slot games where an outcome of the game is determined relative to one or more pay lines, the player may be permitted to select the number of pay lines or the particular pay lines to play. The player might also be permitted to select the size of the wager to place on the game, such as a total wager or a wager per pay line or the like. In one embodiment, the player may select the same play criteria for each game or different play criteria for the games.

Once the player has made the desired game play and wagering selections, the player might select an “exit menu” button or icon 214. The player may then press a start button or icon 216 or provide other input in order to engage in game play. In the event the game is an associated table game, this may indicate that the player has locked in their wager relative to an occurrence of the game at the game table. In the event the game is presented via the gaming machine 22, this may cause the gaming machine 22 to present the games to the player. For example, in the illustrated embodiment, this may comprise the display of a reel spin of the video reels corresponding to both the “Golden Acorn” and “Treasure Hill” games.

In a preferred embodiment, when the player places their wagers, the wager amounts for each game are deducted from the credit balance for that game. In the event the player is awarded winnings, the winning are preferably indicated to the player and added to their credit balances. For example, assume that the player had a 300 credit balance on the Golden Acorn primary game and wagered 50 credits. The primary game status bar 210 would indicate a primary game credit balance of 250 credits. If the player received a winning outcome of the Golden Acorn game having an associate award of 100 credits, the 100 credit win might be indicated in a “win” portion of the primary game status bar 210 and the primary game credit balance is increased from 250 to 350 credits. The same principles apply to each secondary game.

In one embodiment, the player may also transfer credits from a secondary game to the primary game. These credits might comprise credits which the player transferred from the primary game to the secondary game and/or credits won as a result of the play of the secondary game. The player may transfer the credits in various manners, such as by a transfer menu similar to that described above.

Of course, the principles of the invention may be applied to more than two games, such as a primary game and two (or more) secondary games. For example, a player might select a primary game and a second game, a tertiary game, etc. Again, each game preferably has its own credit balance.

In one embodiment, game play is initiated via a single game input by the player, such as via a start button 216. Upon that input, the primary game and at least one secondary game are initiated or played at the same time. The player may be required to provide a game play input each time the player wishes to play the games. In other embodiments, the player could select an “autoplay” feature by which more than one play of the primary and secondary game(s) is initiated. For example, the player might provide input indicating a desire to play the primary game and each secondary game 10 times. The gaming machine 22 could then cause each game to be played/presented 10 times.

As indicated, while the principles of the invention may be applied to a gaming machine 22, they might be applied to other types of gaming machines or devices, such as a VLT 140 or game presentation device 130, among others.

It will be appreciated that the features of the invention may be implemented in other manners than as described above. For example, a player might be permitted to transfer funds from the primary game to a secondary game in other manners than the menu as described above. For example, a player might be permitted to “drag” funds from a primary credit area to a secondary credit area (such as via touch input). Likewise, the player might be permitted to move funds from a secondary game to the primary game in various manners.

An important aspect of the invention is that the player may select which game comprises the primary game and which game(s) comprise the secondary game(s). For example, as illustrated in FIG. 3A, the player might select any of the games as the primary game, and relative to FIG. 3B, the player might select any of the games as a secondary game. In one embodiment, a plurality of game options are presented to the player and the player may select any of those games as the primary or secondary games. In other words, in a preferred embodiment the player is not assigned a single game to comprise the primary game (thus leaving the player with only the choice of secondary game(s)) and upon the player selecting a primary game the one or more secondary game(s) are not automatically assigned.

The invention may be implemented in various manners. In one embodiment, as illustrated in FIG. 1, the gaming system 100 may include a money management or central accounting system. Such a system may include one or more accounting servers or hosts 150. The money management system may also include other devices such as ticket-dispensing kiosks, ticket-cashing kiosks, cash-dispensing kiosks (such as from a credit card or debit card), ATMs, and/or other devices.

In addition, in one embodiment, the accounting host 150 may communicate with one or more external devices or systems. For example, as illustrated in FIG. 1, the accounting host 150 may communicate with one or more financial systems or financial institutions 160. As one example, the accounting host 150 may communicate with a bank which manages one or more bank accounts of a player.

In one embodiment of the invention, the accounting host 150 manages one or more player financial or wagering accounts 170, which accounts may be referred to herein as “central” funds or wagering accounts. Each central wagering account 170 may comprise an electronic wallet or other type of account and may be used by a player to place wagers relative to games presented via the different gaming systems or platforms and to receive winnings or payments from those different gaming systems or platforms.

A player may have one central wagering account or more than one wagering account. Preferably, identification or access information is associated with each central wagering account. This information may be used by a player or the system to identify a particular account relative to a player's activity. The identification information might comprise, for example, a player card, RFID tag or other media which bears or has identifying information associated therewith, or identification information (such as a code, account number or the like) which the player can input to the system 100.

A player must provide funds in order to make wagers. The player might associate funds with their central wagering account 170, such as by requesting a fund transaction with one or more designated external bank accounts (checking or savings account, as one example) or other financial accounts. Such transactions are well known. A player might also deposit funds with a casino (either in cash/coins or electronically) and have the casino or other entity associate those funds with the player's central wagering account 170. A player might also provide the funds to a gaming device (such as in the form of currency, bank card or the like). Those funds might be transferred to the player's central wagering account 170 immediately or they might be credited to the gaming device (such as in the form of one or more credits) and then be transferred to the player's central wagering account at a later time (such as after the player has completed game play at the gaming device, wherein any remaining funds balance at that gaming device is then transferred to the player's central wagering account). A player may also transfer funds from one of their central wagering accounts to another of their central wagering accounts, receive funds from a different player's central wagering account (upon initiation or approval of the other player) or transfer funds to another player's central wagering account(s).

The accounting host 150 may track the number of credits which belong to the player and which are assigned to the primary and/or secondary game(s). Those credits could be tracked relative to a player's wagering account 170, or might be tracked relative to a particular player (such as determined from a player tracking account or the like), or via gaming machine identifier or the like.

For example, a player might provide funds to a gaming machine 22 via their wagering account 170. The accounting host 150 might track, for example, that the player has 1000 credits associated with their account and has moved 500 to a gaming machine 22 for play. The accounting host 150 may further track the player's transfer of 200 credits from the primary game to a secondary game. These credit balances may be updated, such as based upon further transfers, game wins or the like, as reported by the gaming machine 22. In this configuration, the accounting host 150 tracks a master or primary game credit balance and the secondary game credit balances, credits award or won relative to primary or secondary game wins, transfers of credits, and reconciles those credits/balances.

Further, in the event that the player places wagers on games which are played at other devices, the accounting host 150 may track or move funds to those devices. For example, as indicated above, a player may place a wager on a primary video slot game which is presented directly via the gaming machine 22 and a secondary roulette game which is presented via a roulette table (with the results being reported to the gaming machine 22). In that instance, the accounting host 150 may track wager information to establish that funds wagered at the gaming machine 22 by the player are accrued or tied to the roulette table.

Of course, the gaming system 100 might include other systems or devices other than those just described.

The method and system of the invention has numerous advantages and features. For example, the invention permits a player to play multiple games at a single gaming device by funding a primary game and using that primary game as “master”, wherein the player may move funds from that primary game to fund one or more secondary games or the player may consolidate funds by moving funds from the secondary game(s) to the primary game).

Further, once a player has selected a primary game and one or more secondary games, those games may be linked in other manners. For example, a common bonus may be applied to each of the selected games. In the event the bonus event is won relative to one of the secondary games, the bonus award may be applied directly to the primary credit balance or it might be applied to the secondary game credit balance and then be transferred by the player to the primary game credit balance.

It will be understood that the above described arrangements of apparatus and the method there from are merely illustrative of applications of the principles of this invention and many other embodiments and modifications may be made without departing from the spirit and scope of the invention as defined in the claims.

What is claimed is:

1. A method of funding wagers at an electronic gaming machine comprising the steps of:
displaying at least one menu of games to a player via an electronic display of said gaming machine;
receiving input of a selected primary game from said at least one menu of games from said player via an input device of said gaming machine;
receiving input of a selected secondary game from said at least one menu of games from said player;
receiving funds from said player;
crediting said funds to a primary game credit balance assigned to said primary game;
receiving input from said player to transfer a number of credits from said primary game to said secondary game;
reducing said primary game credit balance by said number of credits; and
crediting said number of credits to a secondary game credit balance assigned to said primary game.
